(19) United States
(12) Patent Application Publication
(10) Pub. No.: US 2010/0012584 A1
(43) Pub. Date: Jan. 21, 2010

(54) METHOD FOR ENRICHING ONE OR MORE COMPOUNDS OF A MIXTURE USING A LIQUID MOBILE PHASE CONTAINING A GAS

(75) Inventors: Wieslaw Majewski, Laxou (FR); Eric Valery, Pulnoy (FR); Olivier Ludemann-Hombourger, Pompey (FR)

Correspondence Address: MARSH, FISCHMANN & BREYFOGLE LLP, 8055 East Tufts Avenue, Suite 450, Denver, CO, 80237, US

(73) Assignee: Novasep, Pompey (FR)

(21) Appl. No.: 12/439,047

(22) PCT Filed: Aug. 23, 2007
(86) PCT No.: PCT/FR07/01395

§ 371 Date: Feb. 26, 2009

(30) Foreign Application Priority Data
Aug. 28, 2006 (FR) PCT/FR06/01997

(51) Int. Cl. B01D 15/40

(52) U.S. Cl. 210/635

(57) ABSTRACT

The object of the invention is a method for enriching by chromatography of one or more compounds of a mixture in at least one column using an eluent, characterized in that a liquid mobile phase containing dissolved gas is used as eluent. A further object of the invention in the use in preparative chromatography of an eluent composed of a liquid mobile phase containing a dissolved gas.

### TECHNICAL FIELD

A subject of the invention is a novel method for enrichment by chromatography using a liquid mobile phase containing dissolved gas as well as its use for enriching a compound of a mixture in general, and the use of known devices for its implementation.

### STATE OF THE ART

Various chromatography methods are known, using very varied eluents or solvents, promoting the migration of solutes in the column. Gas phase, liquid phase chromatography (also referred to as High Performance Liquid Chromatography or HPLC), in supercritical or subcritical phase, referred to as SFC for Supercritical (or Subcritical) Fluid Chromatography are known. The eluents used can be pure substances or mixtures, by way of example in the field of supercritical or subcritical chromatography, a co-solvent which can be for example an alcohol is generally used in addition to CO₂.

The term “supercritical state” denotes a state characterized either by a pressure and a temperature respectively greater than the critical pressure and temperature of the substance in the case of a pure substance, or by a pressure and temperature respectively greater than the critical pressure and temperature of the mixture in the case of a mixture. Supercritical fluids have remarkable properties compared with liquids, in particular a lower viscosity and greater diffusivity, which improves separation by chromatography. Chromatography can also be applied to so-called “non-supercritical” fluids referred to as “subcritical”, i.e. in a state characterized either by a pressure greater than the critical pressure and by a temperature lower than the critical temperature in the case of a pure substance, or by a pressure greater than the critical pressures of each of the components of the mixture in the case of a mixture (on this subject, reference may be made to the article by Michel Perrut in Informations Chimie 321, October 1990, pages 166 to 177, “les fluides supercritiques, applications en abondance”).

Whether the eluent is supercritical or subcritical, the pressures are always very high, requiring equipment, as well as operating conditions, suited to these very high pressures.

J Microcolumn Separations 7(5) 477-483 (1995) describes an analytical chromatography system making use of a methanol/H₂O/CO₂ eluent 49/21/30 (mol) at 204 atm. At 26° C., the pressure drop at the outlet of 4 columns is 144.8 atm, whereas for 60° C., the pressure drop is 81.9 atm. Thus, the outlet pressures for the methanol/H₂O/CO₂ mixture are established at 59.2 atm and 122.1 atm for 26 and 60° C. respectively. In the case of use at 26° C., the pressure at the outlet of the columns is lower than the critical pressure, whereas it is greater than the critical pressure for the higher temperature in comparison with the critical pressure of the CO₂ alone. This article defines the “Enhanced-Fluidity Liquid mobile phase” eluent used in “Enhanced-Fluidity Liquid Chromatography” (EFLC), as being a standard HPLC eluent to which significant proportions of a low-viscosity fluid such as CO₂ have been added.

Anal. Chem 1998, 70, 3298-3303 describes an analytical chromatography system using an EFLC type eluent, in this case THF/CO₂ at 260 atm (60/40 and 70/30). The pressure drop values shown in this article were measured on a 2 m capillary column and are difficult to compare with standard 25 cm columns and sometimes (in the case of high flow rates) exceed the pressure in the eluent pump (3000 psi).

Anal. Chem 1999, 71, 2139-2145 describes an analytical chromatography system using various eluents (ethanol/hexane/CO₂, methanol/CO₂, at 170 atm which are of the EFLC type, this document indicating that EFLC type chromatography involves the use of liquefied gases such as CO₂ and CHF₃, combined with polar liquids such as ethanol, as mobile phase. It is indicated that the pressure drop recorded with EFLC type solvents is smaller, which increases the speed of analysis. The outlet pressures are however still very high in this document, the inlet pressure being fixed at 170 atm, whereas the pressure drop is approximately 21 bar at most (for 10% of CO₂ added). The outlet pressure is in this case still higher than the critical pressure (in fact 170 bar minus 21 bar pressure drop is a value clearly greater than the pressure of approximately 74 bar, the critical pressure of CO₂ alone).

Chirality 9:672-677 (1997) describes a chromatography separation method under different operating conditions for the solvent. In particular, this article studies the effects of the addition of CO₂ on the critical points (pressure and temperature). The article studies the methanol/CO₂ binary system, for variable quantities of CO₂. The binary system studied is the methanol/CO₂ eluent with 10 mol. % of CO₂. For this binary system, the critical pressure and temperature are 114 atm and 60° C., respectively. The article studies the effect of the operating conditions on the selectivity, retention and resolution. The article concludes that the optimum resolution is obtained with a supercritical pressure and a subcritical temperature.

The four articles above deal exclusively with analytical chromatography.

A need still remains for chromatography separation methods which are effective, which do not require operating conditions which are too restrictive, but which especially make it possible to collect a mass of enriched or purified product in quantities as large as possible.

None of the above documents describes or suggests the present invention.

### SUMMARY OF THE INVENTION

The invention therefore provides a method of enriching by chromatography one or more compounds of a mixture in at least one column using an eluent, characterized in that a liquid mobile phase containing dissolved gas is used as eluent.

According to an embodiment, the outlet pressure is lower than the critical pressure of the eluent gas.

According to an embodiment, the method is implemented on at least one column having a length-to-diameter L/D ratio of less than 10, for example less than 5.

According to an embodiment, the average linear velocity during the implementation of the enrichment by chromatography is greater than 0.3 cm/s.

According to an embodiment, the injected volume of the solution containing said compound to be enriched represents between 1 and 20% of the void volume of said at least one column, preferably between 2 and 10%.

According to an embodiment, the injection of said mixture into said at least one column is carried out with a liquid.

According to an embodiment of the invention, the eluent is at a temperature lower than the critical temperature of the eluent gas.

According to an embodiment of the invention, the eluent is at a supercritical temperature and at a column outlet pressure lower than the critical pressure of the eluent gas.

According to an embodiment of the invention, the eluent according to the invention is constituted by a liquid mobile phase, said liquid mobile phase contains dissolved gas, preferably dissolved carbon dioxide, and surprisingly, remains homogeneous under the temperature and pressure conditions as defined according to the present invention.

According to an embodiment of the invention, the eluent is at a pressure which corresponds to the minimum pressure at which the eluent would be a homogeneous phase, increased by a value comprised between 1 and 20 bar, preferably between 3 and 10 bar at the outlet of said at least one column.

According to an embodiment of the invention, the eluent comprises a liquid mobile phase containing a gas chosen from carbon dioxide, nitrogen protoxide, light alkanes and fluorinated gases.

According to an embodiment of the invention, the eluent comprises a liquid mobile phase containing dissolved carbon dioxide.

According to an embodiment, the eluent according to the invention is constituted by a homogeneous liquid mobile phase containing dissolved gas at a subcritical pressure and at a supercritical temperature.

According to an embodiment, the eluent according to the invention is constituted by a homogeneous liquid mobile phase containing dissolved gas at a subcritical pressure and at a subcritical temperature.

According to an embodiment of the invention, the eluent liquid is chosen from water in a mixture with the miscible organic solvents, the primary alcohols containing 1 to 4 carbon atoms, the alkanes containing 5 to 10 carbon atoms, acetone, acetonitrile, cyclic ethers and esters.

According to an embodiment of the invention, the eluent is binary, ternary or a mixture with 4 or more components.

According to an embodiment of the invention, the gas content in the eluent is comprised between 5 and 95% by volume, preferably between 10 and 50% by volume.

According to an embodiment of the invention, the method is implemented on a silica-based stationary phase or also implemented on a chiral stationary phase.

According to an embodiment of the invention, the gas is dissolved in the liquid eluent by maintaining sufficient pressure to obtain a homogeneous liquid phase throughout the length of the chromatographic column.

According to an embodiment, the invention relates to the use of the eluent according to the invention, in any preparative chromatography device, continuous or in sequence with at least one column, for enriching one or more compounds of a mixture.

According to an embodiment, the invention relates to the use of an eluent constituted by a liquid mobile phase containing dissolved gas in chromatography systems comprising axial compression columns.

The invention also relates to the use of a preparative chromatography device for implementing the method according to the invention.

According to another embodiment, the invention relates to the use in preparative chromatography of an eluent composed of a fluid mobile phase containing a dissolved gas and at an outlet pressure lower than the critical pressure of the eluent gas and at a temperature lower than the critical temperature of the eluent gas.

According to another embodiment, the invention relates to the use in preparative chromatography of an eluent which is a single phase mixture of a gas and a liquid at a pressure which corresponds to the minimum pressure at which the eluent would be a homogeneous phase, increased by a value comprised between 1 and 20 bar, preferably between 3 and 10 bar.

A subject of the invention is also the use of a subcritical or supercritical preparative chromatography device for the implementation of the method according to the invention.

A subject of the invention is also the use in preparative chromatography of an eluent composed of a fluid mobile phase containing a dissolved gas and at an outlet pressure lower than the critical pressure of the eluent gas and at a temperature lower than the critical temperature of the eluent gas.

A subject of the invention is also the use in preparative chromatography of an eluent which is a single phase mixture of a gas and a liquid at a pressure which corresponds to the minimum pressure at which the eluent would be a homogeneous phase, increased by a value comprised between 1 and 20 bar, preferably between 3 and 10 bar.

The invention offers numerous advantages compared with a standard SFC system. In particular, the operating pressure is lower and/or the solvency is higher. It is possible to carry out the separation with the eluents according to the invention under the pressure conditions conventionally used in HPLC. The installation using the eluents according to the invention, compared with a standard SFC separation device, does not require a high-pressure CO₂ pump, a CO₂ condenser, a cooling bath, a CO₂ evaporator, a hot bath or finally, high-pressure separators. However, a person skilled in the art will appreciate that the SFC equipment is compatible with the eluents according to the invention

The invention makes it possible, compared with HPLC type chromatography, and for a comparable linear velocity, to increase the number of plates and reduce the pressure drops, which leads to better system performances.

The invention can therefore be implemented on standard systems, whether these are SFC or HPLC.

### BRIEF DESCRIPTION OF THE FIGURES

FIG. 1 is a diagrammatic view of an installation according to the invention;

FIG. 2 is a diagrammatic representation of a phase diagram for a binary mixture;

FIG. 3 is a representation of a phase envelope calculation;

FIG. 4 is a representation of a phase envelope according to published data;

FIG. 5 is a representation of a signal from a sensor as a function of the pressure of the eluent;

FIG. 6 represents the separation chromatograms in an elution mode according to the state of the art and according to the invention;

FIGS. 7a and 7b represent the separation chromatograms in an elution mode according to the state of the art and according to the invention, in the case of an overloaded injection.

### DETAILED DESCRIPTION OF EMBODIMENTS OF THE INVENTION

### Chromatographic System.

The invention is implemented with all the chromatography techniques using a stationary phase and an eluent in the state according to the invention.

The chromatography according to the invention can be continuous, discontinuous (batch) or sequential (in particular known as SMB). The invention can be implemented on a single column, or in a multi-column device, single-column devices being preferred here.

SMB technology has been known for a long time, and is the subject in particular of the following patents: U.S. Pat. No. 2,957,927, U.S. Pat. No. 2,985,589, U.S. Pat. No. 3,205,166, U.S. Pat. No. 3,291,726 and U.S. Pat. No. 3,310,486 (UOP). Columns with variable chromatographic lengths can also be used in the invention. Thus, it is possible to implement the invention in a so-called Varicol® system, developed by the Applicant, and corresponding to the patents U.S. Pat. No. 6,136,198, U.S. Pat. No. 6,375,839, U.S. Pat. No. 6,712,973, U.S. Pat. No. 6,413,419 and WO 00/25885. It is also possible to implement the invention in a so-called Cyclojet® system, and corresponding to the patents U.S. Pat. No. 5,630,943 and WO 97/20206, as well as U.S. Pat. No. 6,063,284 and WO 98/51391.

Any other chromatographic method, including batch chromatography, whether or not multi-column, can be used; there can be mentioned the systems known under the names of ModiCon® and PowerFeed®, as well as two-zone SMB chromatography.

The use of supercritical solvents in a multi-column device is described in particular in WO93/22022.

The invention uses the standard phases, such as for example silica-based stationary phases, reversed-phase adsorbents or also chiral stationary phases (CSP). The CSP phase which can be used in the invention can be (i) a cellulose derivative (e.g. esters or carbamates, preferably deposited on silica), optionally grafted, (ii) tartrate phase, (iii) acid and basic CSP phase (Pirkle phase), (iv) an amylose derivative (e.g. esters or carbamates. preferably deposited on silica, optionally grafted), (v) polyacrylamide phase and (vi) others.

Any phase can be used and is determined in standard fashion by routine tests by a person skilled in the art. A suitable stationary phase will exhibit a balance of the following properties a) retention time; b) selectivity; c) load capacity; d) productivity; and e) eluent consumption.

All types of column are suitable for the implementation of the invention. However, it is preferable to use preparative chromatography columns, having a sufficient diameter. Columns having length to diameter L/D ratios less than 10, advantageously less than 5 are preferably used.

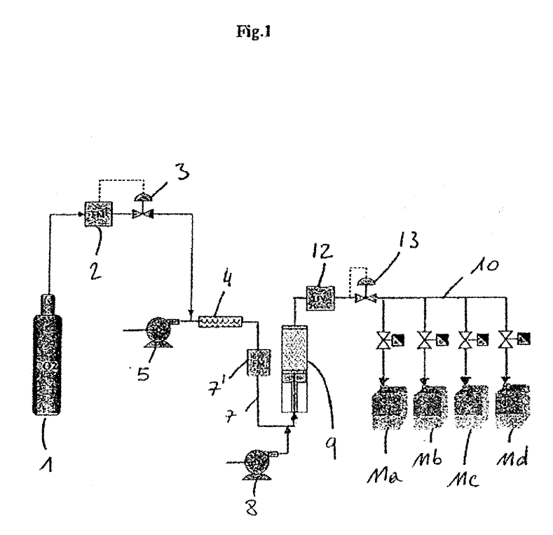

With reference to FIG. 1, a system according to the invention is described. A reservoir 1 of CO₂ under pressure, the flow rate of which is controlled by a flow-meter 2 combined with a valve 3 supplies a mixer 4, for example a static mixer. This mixer 4 is itself also supplied with liquid from a liquid pump 5. The eluent thus obtained is sent to the columns, passing through a flow meter 7′ arranged on the line 7. A pump for the mixture to be separated 8 injects the mixture to be separated into the line 7. The line 7 is connected to the feed of a column 9 (which can be a column with dynamic axial compression). This column 9 feeds, via a draw-off line 10, the collection cups 11a, 11b, 11c and 11d. A detector, for example a UV detector 12 which detects the presence of solute at the column outlet is placed on the line 10. A regulator 13 is arranged on the line 10 to regulate the outlet pressure of column 9. The collection device can incorporate a set of 2-way valves, or a rotary valve type system to at least two collection containers.

### Eluent

The eluent used in the invention is a specific eluent. The eluent according to the invention is a mixture of a gas and a liquid, in a homogeneous phase (or single phase). The terms gas and liquid correspond to the states of the pure substances at an ambient temperature of 23° C. and under normal pressure. For example, CO₂ is classified as a gas in the invention, whereas methanol or ethanol is classified as a liquid in the invention. The eluent according to the invention is not supercritical or subcritical, as it is at a pressure lower than the critical pressure (whereas the supercritical or subcritical eluents are at a pressure which is greater than the critical pressure of the fluid considered). The eluent in the invention is at a pressure lower than the critical pressure, for example at least 5 bar lower than this critical pressure. The pressure of eluent according to the invention is an operating parameter which ensures the homogeneity of the mobile phase. The gas used in the mobile phase is thus ‘dissolved’ in the liquid or liquids used in order to produce the eluent according to the invention. Examples of gases capable of being used in the invention are: carbon dioxide, nitrogen protoxide, the light alkanes (in particular containing 1 to 4 carbon atoms, such as ethane, ethylene), and fluorinated gases (CHF₃).

Examples of liquids capable of being used in the invention are: water in a mixture with the miscible organic solvents (for example water and alcohol or water and acetonitrile, the quantity of water being preferably less than 50% by volume), primary C₁-C₄ alcohols (for example methanol, ethanol, isopropanol), alkanes (in particular containing 5 to 10 carbon atoms, such as hexane, heptane), acetone, acetonitrile, cyclic ethers (for example THF), esters (for example ethyl acetate) and all the organic solvents used for liquid and reversed mobile phase chromatography.

It is possible to form binaries, ternaries, or mixtures with 4 or more components. In general, a gas and a liquid or a gas and two liquids are used.

The quantity of gas dissolved in the liquid is variable, and can be comprised between 5 and 95%, preferably between 10 and 50% by volume. (The use of quantities by volume is practical, because most chromatographic systems use volumetric pumps). The optimum gas content is determined by experimentation.

The eluent according to the invention is “inflated” with the dissolved gas, followed by a reduction in the viscosity and increase in the diffusivity, these two parameters being significant in the chromatographic application.

It is also noted that the solvency of the eluents according to the invention cannot be modified by the addition of gas to the liquid. But it is also possible, by adjusting the pressure and the quantity of gas and more preferably in the case of CO₂, to modify the solvency. Reference can be made, by way of example, to the document Supercrit. Fluids, vol 23, 2002. p 195, for an illustration of the solubility of salicylic acid in propanol as a function of the temperature and pressure of CO₂.

To the extent that it is possible to adjust the properties of the eluent (viscosity, diffusivity, solvency), it is possible to qualify this eluent as neoteric (it is a “tunable” solvent).

### Method of Enrichment or Separation.

The present method is an enrichment method; unlike the methods of the state of the art using mixtures of liquid and gas, the method according to the invention leads to isolated fractions which are used. The invention is the use in preparative chromatography of an eluent which is a liquid mobile phase containing a dissolved gas.

The operating conditions used in the invention are defined in relation to the quantity of gas in the eluent, the type of gas, the type of liquid, and the temperature. It is possible to define an operating pressure according to these elements. In general, the outlet pressure of the chromatography device is fixed and the flow rate is then adjusted (which leads to a given pressure drop).

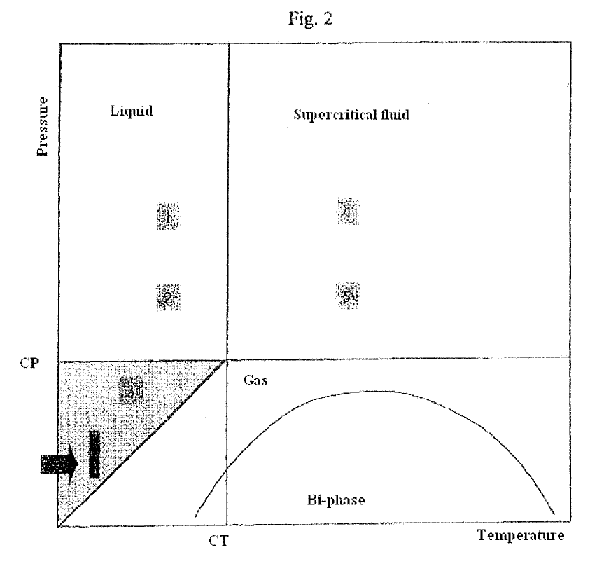

By way of example, for a standard binary of the methanol/CO₂ type, the operation is carried out below the critical pressure, therefore as a first approximation towards 100-110 bar at maximum. The operation is also carried out above the pressure of the appearance of the first bubbles of gas, i.e. as a first approximation towards 30 bar. The zone corresponds to zone 3 in FIG. 2.

With reference to FIG. 2, a phase diagram of a mixture is described, this schematic diagram being an extract from Chirality 9:672-677 (1997). The classifications of the zones 1, 2, 3, 4 and 5 are found in this article. The zones 1 and 2 are at a subcritical temperature and a supercritical pressure. The zones 4 and 5 are at a supercritical temperature and a supercritical pressure. The triangular zone 3 is at a subcritical temperature and a subcritical pressure. In the part with high-temperatures with subcritical pressure, two phases appear (separation of the gas phase and the liquid phase). The invention is implemented in region 3. This is diagrammatically represented by a triangle. It corresponds to this zone for which the solvent is a homogeneous phase, but at a subcritical pressure and at a subcritical temperature. It is also implemented according to a particular embodiment of the invention by means of the characteristic eluent according to the invention in the zone defined by a subcritical pressure and at a supercritical temperature and for which the solvent is a homogeneous liquid mobile phase.

The operating conditions can be defined more precisely, in particular by determining the minimum pressure at which the chromatography is implemented such that the eluent remains in homogeneous phase in all of the chromatographic zones.

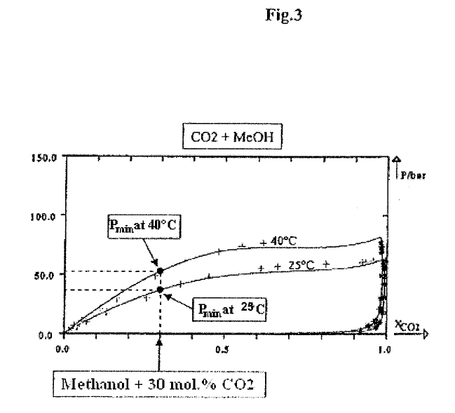

It is possible to use for example the calculated phase envelope method. A phase envelope is calculated for a given binary. This method is described in Pascale Borg, Jean-Noel Jaubert and Felicie Denet, (Fluid Phase Equilibria Vol 191, Issues 1-2, 2001, pp. 59-69). FIG. 3 gives the curves calculated for two chosen temperatures of 25 and 40° C. Minimum pressures for these two temperatures are determined on the curves, for example for a CO₂ content of 30%.

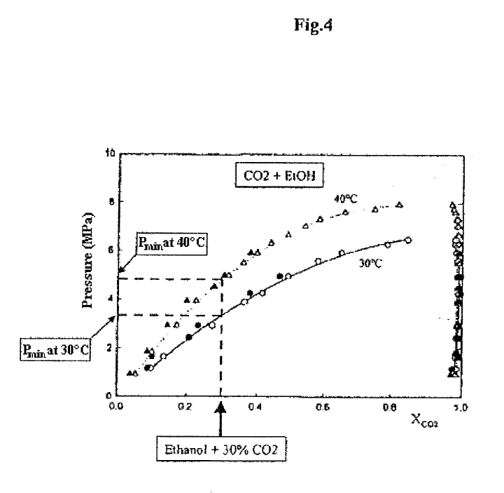

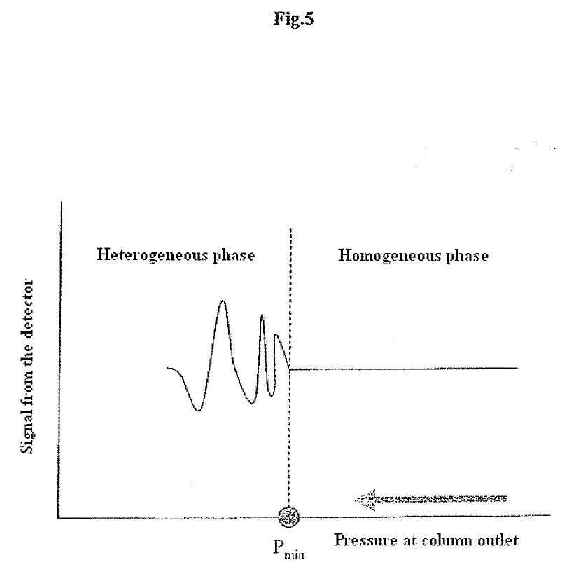

It is also possible to use the data which are published in the literature, for certain mixtures. For example, for the ethanol/CO₂ mixture, it is possible to find these experimental values. FIG. 4 shows an example of such a binary system at 30 and 40° C. (Bull. Korean Chem. 2002, Soc, Vol. 23, No 6). It is also possible to determine this pressure experimentally, for any mixture. A simple experimental method is used which is based on the response of a UV detector at the column outlet as a function of the pressure. For a fixed eluent composition and at a given temperature a descending gradient of the column outlet pressure is applied and recording the signal from the detector is started. If the phase leaving the column is homogeneous, the signal is “clean” and without strong base-line perturbation. The appearance of perturbations with this line indicates the formation of a second phase (in this case the gas phase which is no longer soluble in the eluent liquid). The pressure corresponding to this phenomenon provides the value of Pₘᵢₙ at which it is possible to work with a homogeneous phase. FIG. 5 illustrates this method for a mixture, for example a ternary mixture: C7/IPA/CO₂ at 20° C.

Once the minimum pressure has been determined, for reasons of reliability, the operating pressure at the column outlet is generally fixed at a slightly higher value, for example higher than 5 bar. The operating pressure is therefore Pₘᵢₙ+5. Typically, the pressure Pₘᵢₙ is determined and between 1 and 20 bar, preferably between 3 and 10 bar is added.

The invention can be implemented under specific linear velocity and injected volume conditions.

As regards the linear velocity, it is significantly higher than in the state of the art indicated in the introductory part. In the case of HPLC, the linear velocity is typically of the order of 0.1-0.2 cm/s. In the case of the state of the art relating to EFLC, the linear velocity is of the order of 0.2 cm/s. By way of comparison, the linear velocity, in the invention, is typically greater than 0.3 cm/s.

Such a linear velocity has the advantage that the products exit more rapidly. There is therefore a gain in cycle time: the injection is carried out more often, the production is increased. The drawback conventionally associated with a high linear velocity is that the pressure increases in the column (as the fluid passes through a porous medium). But as the eluent according to the invention has a lower viscosity, the pressure drop is reduced, thus the conventional drawback is compensated for by the quality of the eluent according to the invention.

Another drawback conventionally associated with a high linear velocity is that increasing the velocity involves the risk of reducing the efficiency of the columns. In fact, if the velocity in the columns is increased, this generally promotes broadening of the peaks. Moreover, in the preparative application, the quantity of mixture to be separated (“overloaded injection”) is increased, in order to saturate the phase. Thus, increasing the velocity in the case of a high load, or even of an overloaded injection, is not desirable. Surprisingly, the Applicant has demonstrated that the risk of reducing the efficiency of the column has not proved sufficiently significant to lower the quantity of injectable product allowing a good separation of the products.

The quantity injected in a preparative separation method is significantly greater than in an analytic method, generally the behaviour of the column is no longer linear in a preparative separation method.

The volume of the solution containing the separated products injected into the column can moreover be relatively significant. In the case of the analytical application, the injected volume, as a % of the volume of the empty column, is generally less than 1%. In the case of the invention, the Applicant has surprisingly noted that the injected volume could be increased by as much as several percent, typically up to 20%, without posing any problem. Whilst it can easily be understood that a small injected volume (<1%) does not disturb the system, this is not the case with much larger volumes. The phenomenon is still more surprising when the injection is carried out not with the eluent of the invention, but with only the liquid phase of this eluent.

The invention can nevertheless also use injection loops known in chromatography systems. The mixture to be separated is injected into the loop, then it penetrates into the column. This system is in particular used in SFC. It is possible in the case of the invention to put such a loop in place, with the same eluent in the loop as in the columns. But it is preferable, being simpler, to use only the eluent liquid as injection vehicle.

Thus, the invention provides a method for separating or enriching by chromatography a mixture in at least one column using an eluent, said at least one column being a preparative chromatography column (in particular having an L/D ratio less than 10), the eluent used being a liquid mobile phase containing dissolved gas.

The method according to the invention allows implementation at an average linear velocity greater than 0.3 cm/s and with an injected volume of mixture to be separated which represents between 2 and 20% of the void volume of the chromatography column or columns.

The method according to the invention allows implementation with an injection of said mixture into the column with a liquid (that of the eluent) and with an injected volume of mixture to be separated which represents between 1 and 20% of the void volume of the chromatography column.

The invention is moreover implemented on conventional chromatographic beds. These beds can also be compressed into axial compression columns or into columns for packing and compression of the Pack-n-Sep® type rapid beds (Novasep). The analytical columns are filled with the phase according to a general flash method. In the case of columns with large diameters, i.e. preparative columns, the column is loaded with the phase which is generally in the same solvent as that used for the chromatography. This principle is not applicable to the eluent according to the invention, since it must be handled under pressure. In fact, the phase can be loaded and optionally compressed in the liquid solvent included in the composition of the eluent according to the invention. This use of liquid which is not the same as that used during the chromatography surprisingly poses no operating problem.

The eluent, once it has entrained the solute, becomes isolated fractions. These fractions are treated in a standard fashion in order to separate the dissolved compounds. In general, the gas is lost but the liquid can be recycled. A recycling of gas can nevertheless be provided, if appropriate.

### EXAMPLES

The following examples illustrate the invention without limiting it.

### Example 1

The TSO (trans-stilbene oxide) enantiomers are separated under the following conditions, corresponding to the conditions of analytical chromatography.

Chiralcel Column OD-20 μm, 4.6 mm×25 cm (Chiral Technologies Europe, Illkirch, France)

Temperature 20° C.

Outlet pressure 1 bar (in HPLC mode) and 50 bar in the mode according to the invention with the eluent according to the invention

Liquid eluent: heptane/IPA 70/30 (v/v)

Flow rate of non-expanded eluent=1.4 ml/mm

CO₂ expansion rate 30 and 40%

Pressure drops 9 and 10 bar, respectively.

Volume/quantity of TSO injected: 20 μl/0.64 mg

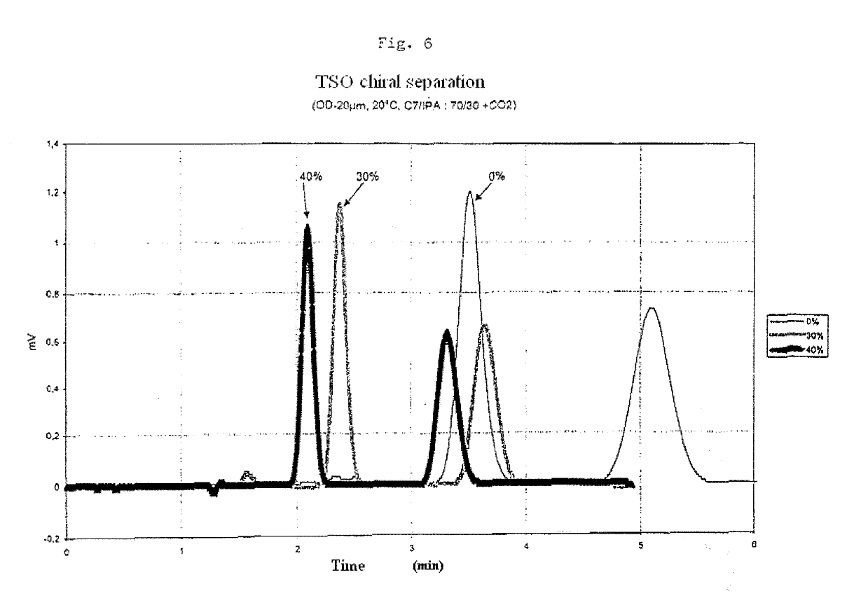

FIG. 6 represents the separation chromatograms in the two elution modes (HPLC and according to the invention). It is clear that the solvent expanded by CO₂ has an influence on the separation. Because of an increase in the volume of eluent and its linear velocity, the retention time of the peaks is clearly reduced and the selectivity has been improved. The linear velocity is of the order of 0.334 cm/s, a given velocity corresponding to the conditions (P, T, and density) of the CO₂ alone at the column outlet.

### Example 2

The TSO (trans-stilbene oxide) enantiomers are separated under the following conditions, corresponding to the conditions of the preparative chromatography, the injection this time being “overloaded”, which corresponds to the normal conditions of use of preparative chromatography.

Chiralcel Column OD-20 μm, 4.6 mm×25 cm (Chiral Technologies Europe, Illkirch, France)

Temperature 20° C.

Outlet pressure 1 bar (non-expanded solvent) and 43 bar with the eluent according to the invention

Liquid eluent: heptane/IPA 70/30 (v/v)

Flow rate of non-expanded eluent=1 ml/min

Flow-rate of expanded eluent=2 ml/min

CO₂ expansion rate 30%

Pressure drops of 12 and 11 bar, respectively

Volume/quantity of TSO injected: 100 μl/3.2 mg, 200 μL/6.4 mg, 250 μl/8 mg;

Injection solvent: isopropanol (IPA)

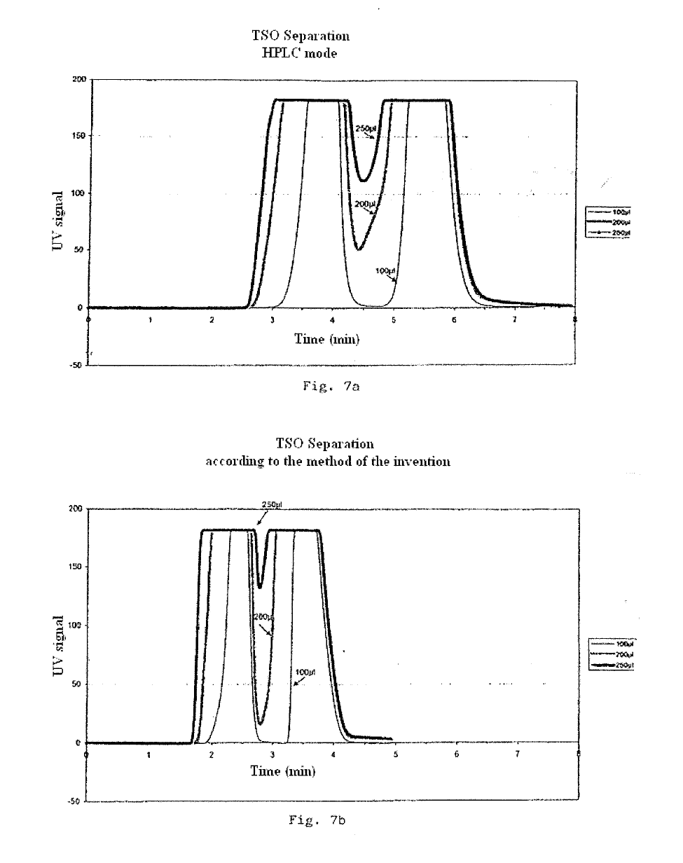

The overload chromatogram (FIGS. 7a and 7b) and the data in Table 1 show that under the conditions according to the invention, for comparable pressure drops, it is possible to carry out a good separation of the enantiomers gaining approximately 1.6 times the level of productivity compared with HPLC. Thanks to a reduction in cycle time it is thus possible to considerably reduce the consumption of liquid solvent. Table 1 below give the values for 200 μl injected.

| | | | | Solvent |
|---|---|---|---|---|
| | | Productivity | | consumption |
| Separation mode | Cycle time (s) | (mg_{load}/h) | Gain | (l/g_{load}) |
| HPLC | 240 | 96 | 1 | 1.25 |
| Dissolved CO₂ | 150 | 154 | 1.6 | 0.55 |
| according to the | | | | |
| invention | | | | |

The linear velocity in the mode according to the invention is of the order of 0.334 cm/s (under the same conditions as in Example 1).

1. Method for enriching by chromatography one or more compounds of a mixture in at least one column using an eluent, wherein a liquid mobile phase containing dissolved gas is used as an eluent.

2. Method according to claim 1, wherein the outlet pressure is lower than the critical pressure of the eluent gas.

3. Method according to claim 1, wherein it is implemented on at least one column having an L/D ratio of less than 10.

4. Method according to claim 3, in which the L/D ratio is less than 5.

5. Method according to claim 1, in which the average linear velocity during the implementation of the enrichment by chromatography is greater than 0.3 cm/s.

6. Method according to claim 1, in which the injected volume of the solution containing said compound to be enriched represents between 1 and 20% of the void volume of said at least one column, preferably between 2 and 10%.

7. Method according to claim 1, in which the injection of said mixture into said at least one column is carried out with a liquid.

8. Method according to claim 1, in which the eluent is at a temperature lower than the critical temperature of the eluent gas.

9. Method according to claim 1, in which the eluent is at a pressure which corresponds to the minimum pressure at which the eluent would be a homogeneous phase, increased by a value comprised between I and 20 bar, preferably between 3 and 10 bar at the outlet from said at least one column.

10. Method according to claim 1, in which the eluent comprises a liquid mobile phase containing a gas chosen from carbon dioxide, nitrogen protoxide, the light alkanes and fluorinated gases.

11. Method according to claim 10, in which the eluent comprises a liquid mobile phase containing dissolved carbon dioxide.

12. Method according to claim 1, in which the eluent liquid is chosen from water in a mixture with the miscible organic solvents, primary alcohols containing 1 to 4 carbon atoms, alkanes containing 5 to 10 carbon atoms, acetone, acetonitrile, cyclic ethers and esters.

13. Method according to claim 1, in which the eluent is binary, ternary or a mixture with 4 or more components.

14. Method according to claim 1, in which the gas content in the eluent is comprised between 5 and 95% by volume.

15. Method according to claim 14, in which the gas content in the eluent is comprised between 10 and 50% by volume.

16. Method according to claim 1, implemented on a silica-based stationary phase.

17. Method according to claim 1, implemented on a chiral stationary phase.

18. Method according to claim 1, wherein the gas is dissolved in the liquid eluent by maintaining a pressure sufficient to obtain a homogeneous liquid phase throughout the length of the chromatographic column.

19. Use of a preparative chromatographic device for the implementation of the method for enriching by chromatography one or more compounds of a mixture in at least one column using an eluent, wherein a liquid mobile phase containing dissolved gas is used as an eluent.

20. Use in preparative chromatography of an eluent composed of a fluid mobile phase containing a dissolved gas and at an outlet pressure lower than the critical pressure of the eluent gas and at a temperature lower than the critical temperature of the eluent gas.

21. Use in preparative chromatography of an eluent according to claim 20, in which the eluent is a single phase mixture of a gas and a liquid at a pressure which corresponds to the minimum pressure at which the eluent would be a homogeneous phase, increased by a value comprised between 1 and 20 bar, preferably between 3 and 10 bar.
